(19) United States
(12) Patent Application Publication
(10) Pub. No.: US 2023/0329156 A1
(43) Pub. Date: Oct. 19, 2023

(54) Latticed modular structure for multi-layer planting

(71) Applicant: CLAY BUILDING CO., LTD., Sejong-si (KR)

(72) Inventor: Moon-Hyoung JUNG, Danyang-gun (KR)

(21) Appl. No.: 18/028,875

(22) PCT Filed: Sep. 28, 2021
(86) PCT No.: PCT/KR2021/013214

§ 371 Date: Mar. 28, 2023

(30) Foreign Application Priority Data
Sep. 29, 2020 (KR) 10-2020-0126684

(51) Int. Cl. A01G 9/02; A01G 9/24; A01G 9/26

(52) U.S. Cl. CPC A01G 9/023; A01G 9/247; A01G 9/26

(57) ABSTRACT

The present invention relates to a latticed modular structure for multi-layer planting and, more specifically, to a latticed modular structure for multi-layer planting, comprising: a wall-shaped wire frame in which a plurality of horizontal wires and vertical wires are arranged in a lattice structure; and a plurality of culture containers arranged in layers inside the wire frame, wherein the culture containers are filled with culture soil for plant cultivation or a culture solution for water culture, and thus the structure can be useful for wall greening, which can improve a living environment such as that of an urban space or houses, and for crop cultivation having high space utilization.

### TECHNICAL FIELD

The present invention relates to a latticed modular structure for multi-layer planting, and more specifically, to a latticed modular structure for multi-layer planting, which includes a wall-shaped wire frame in which a plurality of horizontal wires and vertical wires are arranged in a lattice structure, and a plurality of culture containers arranged in layers inside the wire frame, wherein the culture containers are filled with culture soil for plant cultivation or a culture solution for water culture, and thus the latticed modular structure can be useful for wall greening, which can improve a living environment such as that of an urban space or houses, and for crop cultivation having high space utilization.

### BACKGROUND ART

With the development of industrial society, large populations are rapidly concentrated in cities, and thus residential environments in cities are gradually becoming overcrowded. Green areas around living spaces are gradually disappearing, and as a result, side effects such as air pollution, noise pollution, heat island effect, fine dust, and the like are getting worse.

In order to solve these problems, recently, wall greening, so-called vertical gardening, which makes a three-dimensional green zone by planting plants on vertical structures such as walls, fences, and soundproof walls of buildings, has been proposed as a new solution to improve the urban environment.

When wall greening is implemented, first of all, energy loss through outer walls of buildings can be reduced, and an effect of solving an urban heat island can be expected. In addition, by covering desolate concrete structures with green plants, it is possible to improve the urban landscape, purify the air, and establish a new ecosystem in connection with existing small-scale parks that exist sporadically in urban spaces.

Therefore, conventionally, in Korean Patent No. 10-0947487 (published on Mar. 8, 2010), Korean Patent No. 10-1296738 (published on Aug. 8, 2013), Korean Patent No. 10-1983669 (published on May 23, 2019), etc., several methods have been proposed in relation to wall greening.

Further, in Korean Patent No. 10-0795931 (published on Jan. 11, 2008), a multi-stage differentiated plant cultivation device that enables mass-cultivating even in a narrow space with excellent space utilization by cultivating various crops or horticultural crops in multiple stages in a plastic greenhouse or glass greenhouse is introduced.

### RELATED ART DOCUMENTS

### Patent Documents

Korean Patent No. 10-0947487 (published on Mar. 8, 2010)
Korean Patent No. 10-1296738 (published on Aug. 8, 2013)
Korean Patent No. 10-1983669 (published on May 23, 2019)
Korean Patent No. 10-0795931 (published on Jan. 11, 2008)

### DISCLOSURE

### Technical Problem

The present invention is directed to providing a latticed modular structure for multi-layer planting that can effectively implement wall greening by cultivating plants on a part of an outer or inner wall, a partition wall, a decorative wall, a soundproof wall, or the like of a building, and that can efficiently grow crops such as vegetables, herbs, flowers, and the like useful to humans in a narrow space, as necessary.

The present invention is also directed to providing a latticed modular structure for multi-layer planting that can mass-produce structures modularized with a predetermined standard in advance and can rapidly transfer previously manufactured structures to an installation site to construct the structures at low cost.

### Technical Solution

One aspect of the present invention provides a latticed modular structure for multi-layer planting which includes a wire frame in which a plurality of horizontal wires and vertical wires arranged in a lattice structure are manufactured as one body, wherein the wire frame is formed in a wall shape having both sidewalls corresponding to each other, and has planting spaces S1 arranged in layers in a horizontal direction thereof between the both sidewalls; and a plurality of culture containers each installed inside each of the planting spaces S1, wherein each of the plurality of culture containers has an inner space for storing culture soil for plant cultivation or a culture solution and has an open upper surface, wherein growth spaces S2 in which plants planted in the culture containers grow are provided between the culture containers arranged in layers in the wire frame.

A water supply device including a storage tank for storing water or a culture solution, drainage pipes connected in series or parallel between the storage tank and the culture containers, and a drip pipe for drip-watering the water or a culture solution supplied from the drainage pipes to the culture container may be installed in the modular structure.

The drip pipe may include an inner hose through which the water or culture solution supplied from the drainage pipes of the water supply device is transferred and supplied, and having internal drain holes at regular intervals in a longitudinal direction thereof to pass therethrough, an outer hose which surrounds the inner hose in a spaced apart state and has external drain holes at regular intervals in a longitudinal direction thereof to pass therethrough, and a heat wire which is disposed in a longitudinal direction thereof in a space between the inner hose and the outer hose to electrically generate heat.

### Advantageous Effects

The latticed modular structure for multi-layer planting according to the present invention can be used for a part of an outer or inner wall of a building and can also be variously used for a fence, a soundproof wall, a three-dimensional garden, a planting sculpture, a decorative wall, or the like, and can in particular be used to green both sides of the wall.

The latticed modular structure for multi-layer planting according to the present invention can efficiently grow crops such as vegetables, herbs, flowers, and the like useful to humans in a narrow space, and can stably supply water or a culture solution necessary for crop growth without concern of freezing even in winter.

Further, the latticed modular structure for multi-layer planting according to the present invention can mass-produce structures modularized to have a predetermined standard in advance, and then rapidly transfer the structures to a construction site to construct the structures at low cost as necessary.

### DESCRIPTION OF DRAWINGS

FIG. 1 is a perspective view of a wire frame (10) according to an embodiment of the present invention.

FIG. 2 is a perspective view illustrating a state in which culture containers (20) are installed in the wire frame (10).

FIG. 3 is a perspective view illustrating a state in which blind plates (30) are installed on the wire frame (10).

FIG. 4 is a partially cut-away perspective view illustrating a structure of a double hose (40) for drip irrigation according to an exemplary embodiment of the present invention.

FIG. 5 is a cross-sectional view illustrating a state of use of a latticed modular structure for multi-layer planting according to the present invention.

### MODES OF THE INVENTION

Hereinafter, the present invention will be described in detail with reference to the accompanying drawings. However, since the accompanying drawings illustrate exemplary embodiments of the present invention, the scope of the present invention is not limited by these embodiments. In addition, even when a configuration is essential for carrying out the present invention, detailed descriptions of matters that are introduced in the related art or can be easily implemented by those skilled in the art from known technologies will be omitted.

A latticed modular structure for multi-layer planting according to the present invention may include a wire frame 10 in which a plurality of horizontal wires 11 and vertical wires 12 arranged in a lattice structure are manufactured as one body, and a plurality of culture containers 20 disposed in layers inside the wire frame 10, and blind plates 30 and a water supply device may be additionally installed in the latticed modular structure for multi-layer planting.

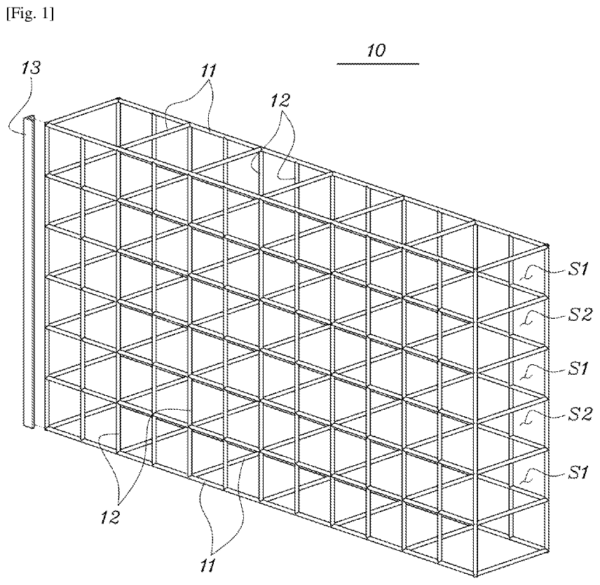

First, the wire frame 10 is manufactured in a wall shape having both sidewalls corresponding to each other by overlapping the horizontal wires 11 and the vertical wires 12 having a diameter of about 3 to 5 mm in a lattice structure, as illustrated in FIG. 1. Planting spaces S1 in which plants can grow and growth spaces S2 may be arranged in layers in a horizontal direction thereof between the horizontal wires 11 and the vertical wires 12 inside the wire frame 10.

L-shaped steel reinforcing beams 13 may be attached to edges of sides of the wire frame 10. The reinforcing beams 13 serve to structurally more firmly support the wire frame 10. Although one reinforcing beam 13 is illustrated in FIG. 1 for convenience of description, the reinforcing beams 13 may actually be installed at all 12 edges.

Further, for example, in the reinforcing beam 13, a hanger part (not illustrated) that hangs and lifts a hook of a crane when the modular structure manufactured according to the present invention is transferred, and a connection part (not illustrated) that can connect and arrange a plurality of modular structures as one body when the plurality of modular structures are constructed may be installed. For example, a conventional O-ring may be used as the hanger part, and uneven coupling structures corresponding to each other may be used as the connection part.

A shape of the wire frame 10 may be a flat rectangular parallelepiped shape with both sidewalls flat, but may be an arc shape with both sidewalls gently curved (not illustrated), as necessary, and the wire frame 10 may be made in various other curved structures. A shape of the modular structure according to the present invention is determined according to the shape of the wire frame 10.

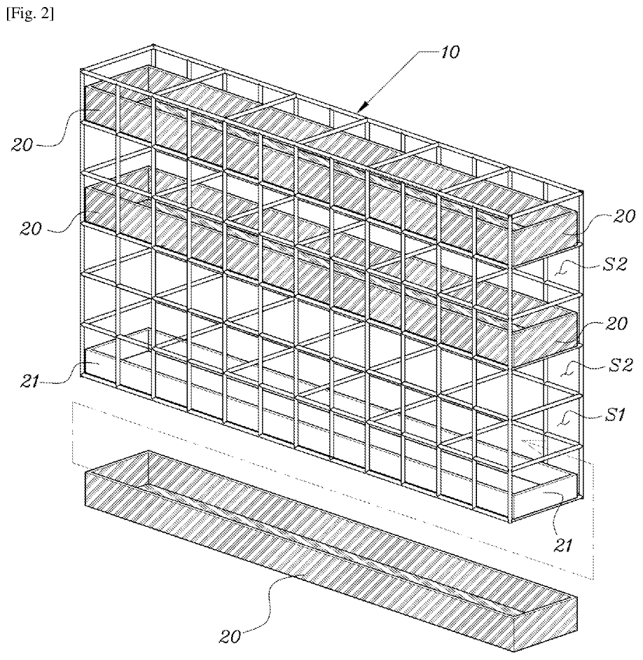

As illustrated in FIG. 2, the culture containers 20 are each installed in layers inside each of the planting spaces S1 of the wire frame 10, have an inner space for storing culture soil for plant cultivation or a culture solution for water culture, and have a structure having an open upper surface. The growth spaces S2 sufficiently spaced apart from each other so that the plants planted in the culture soil or culture solution of the culture containers 20 can grow are provided between the culture containers 20 arranged in layers in the planting spaces S1 of the wire frame 10. A ratio in height between the planting space S1 and the growth space S2 may be appropriately adjusted according to the type of cultivated plant.

Any material as long as it does not hinder the growth of plants, has air permeability, and has a bearing capacity sufficient to store the culture soil for plant cultivation or the culture solution for water culture may be used as a material of the culture container 20. When growing plants using culture soil, one or more of wood, metal, synthetic resin, non-woven fabric, and fabric, having air permeability, may be used as the material of the culture container 20, and when growing plants using a culture solution, it is preferable to use a culture container 20 made of metal or synthetic resin that can block leakage of the solution.

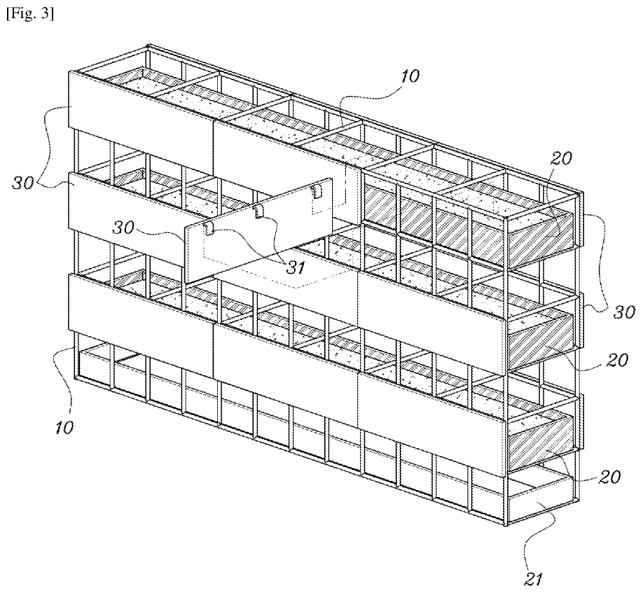

As illustrated in FIG. 3, the blind plates 30 for covering the culture containers may be attached to regions corresponding to the planting spaces S1 on both sidewalls of the wire frame 10. In this case, any conventional attachment method may be used as an attachment method of the blind plate 30, but it is preferable that hangers 31 that can hang and fix the blind plate 30 to the wire frame 10 be installed on an inner surface of the blind plate 30.

The blind plates 30 serve to cover both side surfaces of the culture containers or both side surfaces of the planting space S1 and the growth space S2 in which the culture container 20 is not installed and decorate an appearance of the wire frame 10. Therefore, when the culture container 20 is made of a material such as wood and has an aesthetic appearance so that there is no need to cover the culture container 20, there is no need to install the blind plate 30.

In the modular structure according to the present invention, the water supply device (not illustrated) that supplies water to the culture soil stored in the culture container 20 or replenishes the culture solution may be additionally installed. According to an exemplary embodiment of the present invention, the water supply device may include a storage tank for storing water or a culture solution, drainage pipes connected in series or parallel between the storage tank and the culture containers 20, and a drip pipe for drip-watering the water or culture solution supplied from the drainage pipes to the culture container 20.

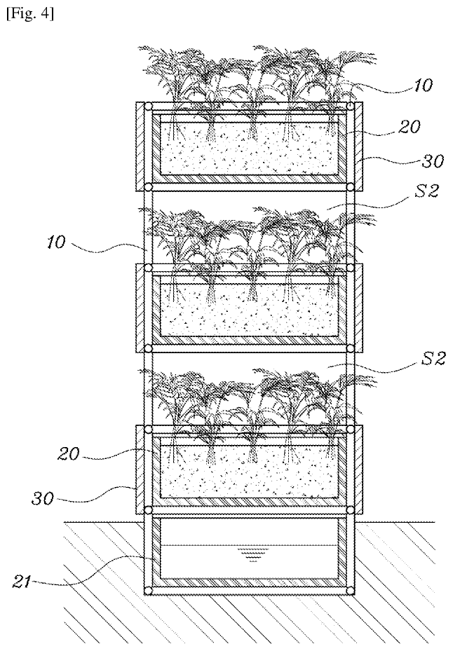

FIG. 4 illustrates a structure of a double hose 40 for drip irrigation suitable for use as the drip pipe of the water supply device, and the double hose 40 for drip irrigation may include an inner hose 41, an outer hose 42, and a heat wire 43. The inner hose 41 is a hose through which the water or culture solution supplied form the drainage pipes of the water supply device is transferred and supplied, and has internal drain holes 41a at regular intervals in a longitudinal direction thereof to pass therethrough.

The outer hose 42 is a hose which surrounds the inner hose 41 in a spaced apart state and has a structure having external drain holes 42a at regular intervals in a longitudinal direction thereof to pass therethrough. The internal drain holes 41a and the external drain holes 42a may each be installed in one row or two rows on each of bottom surfaces of the inner hose 41 and the outer hose 42.

The heat wire 43 is a wire which is disposed in a longitudinal direction thereof in a space between the inner hose 41 and the outer hose 42, and functions to electrically generate heat so that the water or culture solution supplied to the inner hose 41 and the outer hose 42 does not freeze in winter. One to three heat wires 43 may be disposed inside one double hose 40 as necessary.

Further, separation members 44 may be installed between the inner hose 41 and the outer hose 42 at regular intervals in a longitudinal direction thereof. The separation members 44 function to maintain an interval between the inner hose 41 and the outer hose 42 constantly, and may include a fixing ring 44a closely inserted into an outer diameter surface of the inner hose 41, and a plurality of extension arms 44b that radially extend from the fixing ring 44a. Each of end portions of the extension arms 44b supports an inner diameter surface of the outer hose 42. Therefore, the water or the culture solution may be moved through spaces between the extension arms 44b, and the heat wire 43 passes through the spaces.

The double hose 40 for drip irrigation may be embedded in the culture soil stored in the culture container 20, installed on the culture soil, or installed in a drainpipe for water culture. When the double hose 40 is used, it is possible to stably supply the water or the culture solution required for the culture container 20 without concern of freezing the drip pipe even in harsh winter weather.

That is, power may be supplied to the heat wire 43 in advance according to the weather forecast so that freezing of the double hose 40 may be prevented, and when the double hose 40 is frozen due to unexpected weather, it is possible to easily and rapidly thaw the double hose 40 using the heat wire 43. For reference, since the drainage pipes of the water supply device are exposed to the outside, it is possible to install a warming device to prevent freezing of the drainage pipes, and even when the drainage pipes are frozen, it is possible to easily thaw the drainage pipes.

Meanwhile, when humidity of the culture soil is measured and the humidity does not reach preset humidity, a humidity sensor that controls to automatically supply water or a culture solution and a flow rate control valve that adjusts a flow rate of the water supply device in association with the sensor may be installed in the water supply device. In addition, a supply pump for forcibly supplying water or a culture solution and a temperature sensor for controlling power with respect to the heat wire according to external temperature may be installed.

Further, the drain holes may pass through each of the culture containers 20, and a water trap 50 may be installed on a bottom surface of the culture container 20 disposed on a lowermost layer. Accordingly, even when water is supplied to only the culture container 20 disposed on an uppermost layer, the excessive water may gradually flow down to the culture containers 20 disposed on lower layers. For example, when the modular structure of the present invention is installed indoors, the water trap 50 functions to prevent surrounding regions from being contaminated due to the excessive water or culture solution supplied to the culture container 20. The water or the culture solution collected in the water trap 50 may be reused.

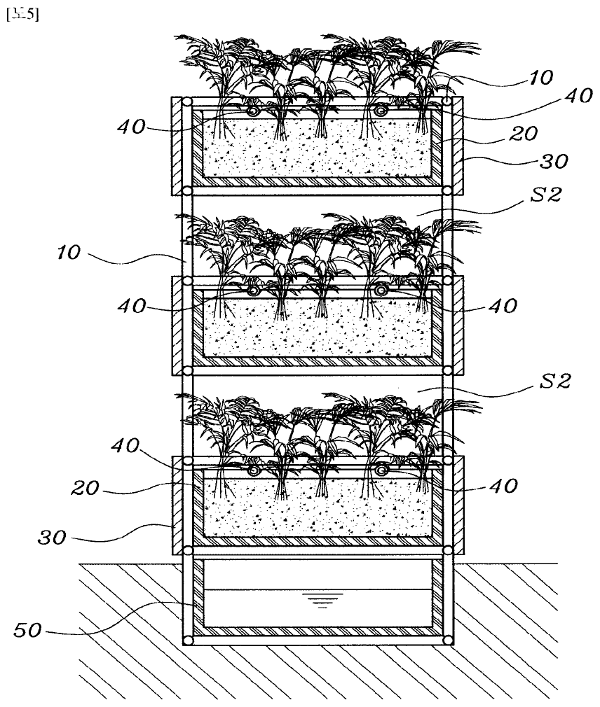

As illustrated in FIG. 5, the latticed modular structure for multi-layer planting according to the present invention can be usually used for an outer or inner wall of a building and can also be variously used for a fence, a soundproof wall, or a decorative wall, and can in particular be used to green both surfaces of the wall.

### REFERENCE NUMERALS

10: WIRE FRAME
11: HORIZONTAL WIRE
12: VERTICAL WIRE
13: REINFORCING BEAM
20: CULTURE CONTAINER
30: BLIND PLATE
31: HANGER
40: DOUBLE HOSE FOR DRIP IRRIGATION
41: INNER HOSE
42: OUTER HOSE
43: HEAT WIRE
44: SEPARATION MEMBER
50: WATER TRAP
S1: PLANTING SPACE
S2: GROWTH SPACE

1. A latticed modular structure for multi-layer planting comprising:
a wire frame in which a plurality of horizontal wires and vertical wires arranged in a lattice structure are manufactured as one body, wherein the wire frame is formed in a wall shape having both sidewalls corresponding to each other, and has planting spaces (S1) arranged in layers in a horizontal direction thereof between the both sidewalls; and
a plurality of culture containers each installed inside each of the planting spaces (S1), wherein each of the plurality of culture containers has an inner space for storing culture soil for plant cultivation or a culture solution and has an open upper surface,
wherein growth spaces (S2) in which plants planted in the culture containers grow are provided between the culture containers arranged in layers in the wire frame.

2. The latticed modular structure for multi-layer planting of claim 1, wherein blind plates that cover the culture containers are attached to both sidewalls of the wire frame.

3. The latticed modular structure for multi-layer planting of claim 2, wherein a hanger that hangs and fixes the blind plate to the wire frame is installed on an inner surface of the blind plate.

4. The latticed modular structure for multi-layer planting of claim 1, wherein L-shaped steel reinforcing beams that reinforce a support structure of the wire frame are attached to edges of sides of the wire frame, and at least one of a hanger part that hangs and lifts a transfer hook and a connection part that connects and arranges two or more modular structures to each other is installed in the reinforcing beam.

5. The latticed modular structure for multi-layer planting of claim 1, wherein a water supply device including a storage tank for storing water or a culture solution, drainage pipes connected in series or parallel between the storage tank and the culture containers, and a drip pipe for drip-watering the water or a culture solution supplied from the drainage pipes to the culture container is installed in the modular structure.

6. The latticed modular structure for multi-layer planting of claim 5, wherein the drip pipe includes an inner hose through which the water or culture solution supplied from the drainage pipes of the water supply device is transferred and supplied, and having internal drain holes at regular intervals in a longitudinal direction thereof to pass therethrough, an outer hose which surrounds the inner hose in a spaced apart state and has external drain holes at regular intervals in a longitudinal direction thereof to pass therethrough, and a heat wire which is disposed in a longitudinal direction thereof in a space between the inner hose and the outer hose to electrically generate heat.

7. The latticed modular structure for multi-layer planting of claim 6, wherein a plurality of separation members that maintain an interval between the both hoses are installed between the inner hose and the outer hose.

8. The latticed modular structure for multi-layer planting of claim 1, wherein drain holes pass through each of the culture containers, and a water trap is installed on a bottom surface of the culture container disposed on a lowermost layer.
